(19) United States
(12) Patent Application Publication
(10) Pub. No.: US 2015/0056954 A1
(43) Pub. Date: Feb. 26, 2015

(54) CALL REDIRECTION METHOD IMPLEMENTED IN A TELECOMMUNICATION SYSTEM AND CORRESPONDING SYSTEM

(71) Applicant: GEMALTO SA, Meudon (FR)

(72) Inventors: Jean-Rémi Quiriconi, La Ciotat (FR); Didier Morel, La Ciotat (FR)

(73) Assignee: GEMALTO SA, Meudon (FR)

(21) Appl. No.: 14/364,887

(22) PCT Filed: Dec. 7, 2012
(86) PCT No.: PCT/EP2012/074871

§ 371 Date: Nov. 4, 2014

(30) Foreign Application Priority Data
Dec. 12, 2011 (EP) 11306639.3

(51) Int. Cl. H04M 3/54; H04W 12/10; H04W 4/16

(52) U.S. Cl. CPC H04M 3/54; H04W 4/16; H04W 12/10
USPC 455/411

(57) ABSTRACT

In a call redirection method, an application of a second telecommunications terminal requests one of the active numbers in the security element of a first terminal. The application transmits a request for an active telephone number in the security element to its operator, and the latter retransmits it to a manager of the security element having knowledge of the active subscription in the security element. At least one subscription is inactive and at least one subscription is active. Each subscription has a corresponding call number. A call number is called an active call number if the corresponding subscription is active, and a call number is called an inactive call number if the corresponding subscription is inactive. The method includes composing the telephone number corresponding to one of the active subscriptions or prompting the user of the second terminal to validate the call to one of these active numbers.

The field of the invention is that of telecommunications. More specifically, the present invention relates to a call redirection method implemented in a telecommunication system and a corresponding system.

In a telecommunications system such as the GSM, UMTS or LTE (for “Long Term Evolution”) systems, terminals can communicate with one another by taking out subscriptions with radiotelephone operators. These terminals are generally mobile ones (telephones, laptops, PDAs, . . . ) and each one contains a security element of the SIM or USIM type containing security data able to establish communications. This security data more particularly consists of an IMSI identifier and an encryption key Ki making it possible to authenticate the subscriber with the operator which it has taken out a subscription with. The terminals can also be fixed. The invention also applies to communications between machines (M2M).

A security element may also be in the form of a chip containing an application of the SIM type. This chip can be soldered into the terminal and fulfils the function of the above-mentioned card. Then the UICC is no longer removable from the terminal and will subsequently be called an e-UICC.

A security element generally contains a single subscription, but it has been envisaged to have it support several subscriptions, either taken out with the same operator or taken out with different operators. Then the user may select one subscription among the others, according to his/her geographical position, to the time, to the network coverage available . . . . Let us examine the example of a French user who has taken out a subscription with a French operator, and who often travels abroad, for example to Germany. This user should rather take out a subscription with a German operator too, in order to be able to communicate in Germany without being in “roaming” situation, with respect to the French operator. Once in Germany, the user will switch from his/her subscription with the French operator to his/her subscription with the German operator for example using the man-machine interface of his/her terminal. The same is true for a user who wishes to have two subscriptions in his/her terminal, a professional one and a private one. He/she will then activate his/her professional subscription when going to work and will activate his/her private subscription back home.

The subscription may be automatically changed either on the user's initiative, depending on his/her geographical position (geo-location), or initiated by an external element which controls the switching from one subscription to another.

In the present invention, one or more subscription(s) is/are active and at least one subscription is inactive.

The problem with these multiple subscriptions within a single terminal is that to each subscription corresponds a different call number.

Thus, it is not possible to call a subscriber or to send him/her data (e.g. SMS or MMS) if the corresponding subscription is not active. For example, if a user A has a terminal comprising a security element containing two subscriptions ABO 1 and ABO 2, with the ABO 1 subscription corresponding to a telephone number (MSISDN) +123 and the ABO 2 subscription corresponding to a telephone number +456, the user can be reached at number +123 only if the ABO 1 subscription is active. Similarly, he/she can be reached at number 456 only if the ABO 2 subscription is active. A user B will not be able to call user A at number +123 if the ABO 2 subscription is active in the security element of user A's terminal. Conversely, user B will not be able to call user A at number +456 if the ABO 1 subscription is active in the security element of the user A's terminal. Call here means any attempt to communicate, whether through voice or data.

The same is true for the management of the subscriptions in the security element. A security element is usually managed by an OTA platform that needs to know the subscriber's active telephone number to be able to transmit it data or programs.

The present invention is especially aimed at overcoming these drawbacks.

More specifically, one object of the invention is to provide a method enabling a user B to reach a user A having several subscriptions, with at least one subscription being inactive (one or more subscription(s) can be active).

This object, and others which will be mentioned hereinafter, are achieved by a method according to claim 1.

The invention also relates to a system according to claim 5.

The present invention will be better understood upon reading the following description of a preferred embodiment of the invention given for illustrative and not restrictive purposes, and the appended drawings wherein:

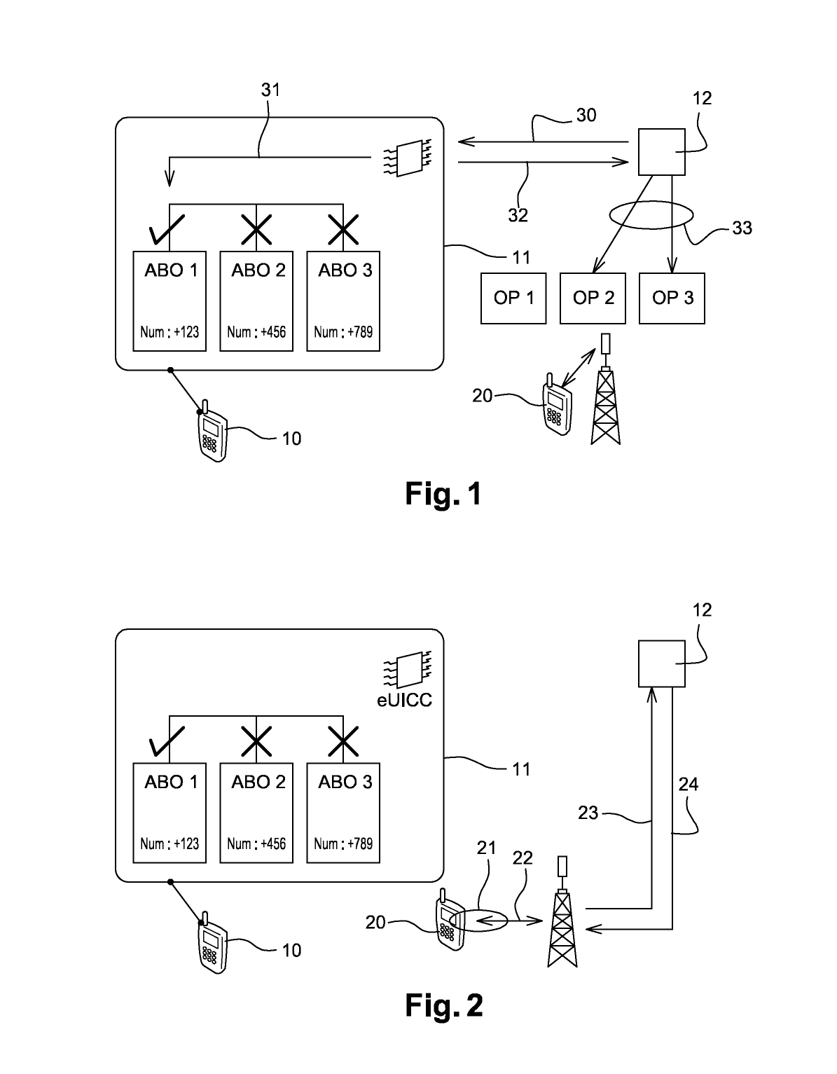

FIG. 1 shows a first embodiment of the method according to the present invention;

FIG. 2 shows an alternative solution to the first embodiment of the method according to the present invention.

FIG. 1 shows a first embodiment of the method according to the present invention.

In this embodiment, a first telecommunication terminal 10 includes or cooperates with a security element 11 (a SIM, USIM or e-UICC card, for instance) containing security data corresponding to several subscriptions. Here, three subscriptions ABO 1 to ABO 3 are present in the security element 11. The subscriptions may have been taken out with the same or different operator(s). In FIG. 1, the ABO 1 to ABO 3 subscriptions have been taken out with three different operators, respectively OP 1, OP 2 and OP 3 each one managing its own network.

As indicated above, one or more subscription(s) can be simultaneously active and at least one subscription is not active. Here, the ABO 1 subscription only is active, whereas the ABO 2 and ABO 3 subscriptions are inactive.

To each subscription corresponds a call number: the owner of the terminal 10 can be reached at (MSISDN) telephone number +123 thanks to the ABO 1 subscription, at number +456 thanks to the ABO 2 subscription and at number +789 thanks to the ABO 3 subscription.

In the following description, a call number is called an active call number if the corresponding subscription is active (i.e. here +123) and a call number is called an inactive call number if the corresponding subscription is inactive (which is the case for the call numbers +456 and +789).

If the user of a second terminal 20 wants to contact the user of the first terminal 10, he/she must compose +123. Now, the user of the second terminal 20 can not know which subscription is active in the first terminal 10.

To this end, the present invention provides the use of a manager 12 of the security element 11. This manager 12 can communicate with the security element by radio and knows which one is the active subscription (ABO 1) in the security element 11, thanks to one of the three following mechanisms, given as examples:
The manager 12 can transmit to the security element 11, during a step 30, a command to activate a subscription (here the ABO 1 subscription). In a step 31, the security element activates the ABO 1 subscription and returns an acknowledgement of receipt and a confirmation that the ABO 1 subscription has been activated, during a step 32. The manager 12 thus knows that the ABO 1 subscription is active in the security element 11.
The user of the terminal 10 may also willingly activate the ABO 1 subscription, by interacting with the man-machine interface of the terminal 10 (typically the keyboard). The step 32 then consists in informing the manager 12 that the ABO 1 subscription is active.
An external event may also initiate the activation of the ABO 1 subscription: detection that the country and therefore the preferred operator has changed, insufficient network coverage on one of the other subscriptions and switching from one subscription (ABO 2 or ABO 3) to the ABO 1 subscription. The step 32 then consists here in informing the manager 12 that the ABO 1 subscription is active.

Since it knows which one is the active subscription in the security element 11, the manager 12 knows that the terminal 10 can be reached through the telephone number +123.

The manager 12 is able to communicate with the operator(s) of the ABO 1 to ABO 3 subscriptions.

According to the invention, during a step 33, the manager 12 transmits to the OP 2 and OP 3 operators (whose subscriptions are not active) information in that the active subscription is the ABO 1 subscription. These operators then redirect the call to the active ABO 1 subscription so that they can retransmit the inactive call numbers (+456 for the OP 2 operator and +789 for the OP 3 operator) to the active call number +123. Thus, if the user of the terminal 20 contacts the user of the terminal 10 at one of these inactive numbers, these will be redirected to the OP 2 or OP 3 operator's network so that the terminal 10 can be contacted at its active number (+123).

FIG. 2 shows an alternative solution to the first embodiment of the method according to the present invention.

The configuration of the system is substantially the same as that of FIG. 1: the first terminal 10 cooperates with a security element 11 containing several subscriptions only one of which is active at a time, or at least, one subscription is not active. The manager 12 knows the active subscription(s) in this security element (here ABO 1 too).

The difference with respect to the system described while referring to FIG. 1 is that the second (the caller's) terminal 20 includes an application (applet) 21 whose function is to request one of the active numbers in the security element 11 (since it has no knowledge of the active subscription(s)). The application 21, preferably located in its own security element transmits a request for the active telephone number in the security element 11, during a step 22, to its operator which transmits it, during a step 23, to the manager 12. The latter, having knowledge of the active subscription (ABO 1), transmits, during a step 24, information on the active subscription(s) in the security element 11. Then the application 21 may either directly compose the telephone number corresponding to one of the active subscriptions, or prompt the user of the terminal 20 to validate the call to one of these active numbers.

The invention also relates to a telecommunications system comprising:
a first telecommunication terminal 10 cooperating with a security element 11 containing security data corresponding to several subscriptions (ABO 1 to ABO 3) with at least one telecommunications operator's (OP1 to OP3) network, at least one subscription being inactive and at least one subscription being active, to each subscription corresponding a call number, a call number being called an active call number if the corresponding subscription is active, a call number being called an inactive call number if the corresponding subscription is inactive;
a manager 12 of the security element 11 having knowledge of the active subscription in the security element 11;
at least one telecommunications operator (OP 1 to OP 3) network, with this manager 12 of the security element 11, comprising means for transmitting to the operator's network information on the active subscription so that the latter redirects an inactive call number composed by a second telecommunication terminal 20 to the active call number.

The manager 12 comprises means for controlling the activation of one of the subscriptions in the security element 11 and the security element 11 comprises means for confirming the activation of the subscription with the manager 12.

In the event that each one of the subscriptions (ABO 1 to ABO 3) has been taken out with a different operator (OP 1 to OP 3), the manager 12 comprises means for informing the operators whose subscriptions are not active, so that each one can redirect the inactive call number composed by the second telecommunication terminal 20 to the active call number.

The second telecommunication terminal can also be formed by an OTA platform used for managing data or programs included in the active subscriptions.

The present invention integrates a security element comprising several subscriptions into several security elements (UICCs) each one comprising a subscription. As a matter of fact, there is no difference between a terminal comprising a single security element containing several subscriptions and a terminal comprising several security elements (e.g. two SIM cards), each one containing a subscription. A terminal of this type is generally called a “dual slot” because it enables the alternative use of two SIM cards.

1. A call redirection method implemented in a telecommunication system comprising:
a telecommunication terminal, called the second terminal, comprising an application whose function is to request one of the active numbers in the security element of a first terminal, said application transmitting a request for an active telephone number in said security element to its operator so that the operator retransmits it to a manager of said security element having knowledge of the active subscription in the security element, at least one subscription being inactive and at least one subscription being active, for each subscription there is a corresponding telephone number, wherein a telephone number is called an active call number if the corresponding subscription is active, and a call number is called an inactive call number if the corresponding subscription is inactive,
said method including composing the telephone number corresponding to one of said active subscriptions or prompting the user of said second terminal to validate the call to one of the active numbers.

2. A method according to claim 1, wherein said manager of said security element controls the activation of one of said subscriptions in said security element and wherein said security element confirms the activation of said subscription with said manager.

3. A method according to claim 1, wherein each of said subscriptions is associated with a different operator and wherein said manager informs the operators whose subscriptions are not active so that they redirect said inactive call numbers composed by said second telecommunication terminal to said active call number.

4. A method according to claim 1, wherein said security element is an e-UICC or a set of UICCs.

5. A telecommunication system comprising a telecommunication terminal, called the second terminal, comprising an application whose function is to request one of the active numbers in the security element of a first terminal, said application transmitting a request for an active telephone number in said security element to its operator so that the operator retransmits it, to a manager of said security element having knowledge of the active subscription in said security element, at least one subscription being inactive and at least one subscription being active, for each subscription there is a corresponding telephone number, wherein a telephone number is called an active call number if the corresponding subscription is active, and a call number is called an inactive call number if the corresponding subscription is inactive,
wherein said application is configured to compose the telephone number corresponding to one of said active subscriptions or to prompt the user of said second terminal to validate the call to one of the active numbers.

6. A system according to claim 5, wherein said manager of said security element comprises means for controlling the activation of one of said subscriptions in said security element and wherein said security element comprises means for confirming the activation of said subscription with said manager.

7. A system according to claim 5, wherein each of said subscriptions is associated with a different operator and wherein said manager comprises means for informing the operators whose subscriptions are not active so that each of the latter redirects the inactive call number composed by said second telecommunication terminal to said active call number.

8. A system according to claim 5, wherein said security element is an e-U ICC or a set of UICCs.
